(19) United States
(12) Patent Application Publication
(10) Pub. No.: US 2014/0220328 A1
(43) Pub. Date: Aug. 7, 2014

(54) STRANDS, NETTINGS, DIES, AND METHODS OF MAKING THE SAME

(71) Applicant: 3M INNOVATIVE PROPERTIES COMPANY, St. Paul, MN (US)

(72) Inventors: Ronald W. Ausen, St. Paul, MN (US); Thomas P. Hanschen, Mendota Heights, MN (US); William J. Kopecky, Hudson, WI (US)

(73) Assignee: 3M INNOVATIVE PROPERTIES COMPANY, St. Paul, MN (US)

(21) Appl. No.: 14/240,879

(22) PCT Filed: Aug. 14, 2012
(86) PCT No.: PCT/US2012/050746

§ 371 Date: Feb. 25, 2014

Related U.S. Application Data
(60) Provisional application No. 61/530,521, filed on Sep. 2, 2011.

(51) Int. Cl. B29C 47/12; B29C 47/00; D04H 3/018

(52) U.S. Cl. CPC B29C 47/128; D04H 3/018; B29C 47/0014
USPC 428/219; 442/51; 428/220; 264/103; 425/462; 264/172.15

(57) ABSTRACT

Netting (1101) comprising an array of polymeric strands (1102,1104), wherein the polymeric strands are periodically joined together at bond regions throughout the array, and wherein at least a plurality (i.e., at least two) of the polymeric strands have a core (1114) of a first polymeric material and a sheath (1103) of a second, different polymeric material. Nettings described herein have a variety of uses, including wound care, tapes, filtration, absorbent articles, pest control articles, geotextile applications, water/vapor management in clothing, reinforcement for nonwoven articles, self bulking articles, floor coverings, grip supports, athletic articles, and pattern coated adhesives.

### CROSS REFERENCE TO RELATED APPLICATION

This application claims the benefit of U.S. Provisional Patent Application No. 61/530,521, filed Sep. 2, 2011, the disclosure of which is incorporated by reference herein in its entirety.

### BACKGROUND

Polymeric nets are used for a wide variety of applications, including reinforcement of paper articles or cheap textiles (e.g., in sanitary paper articles, paper cloth, and heavy duty bags), non-woven upholstery fabrics, window curtains, decorative netting, wrapping material, mosquito netting, protective gardening netting against insects or birds, backing for growing of grass or plants, sport netting, light fishing netting, and filter materials.

Extrusion processes for making polymeric nets are well known in the art. Many of these processes require complex dies with moving parts. Many of these processes can only be used to produce relatively thick netting with relatively large diameter strands and/or relatively large mesh or opening sizes.

Polymeric netting can also be obtained from films by slitting a pattern of intermittent lines, which are mutually staggered, and expanding the slit film while stretching monoaxially or biaxially. This process tends to produce netting of a relatively large mesh and with relatively weak cross-points.

There exists a need for a relatively simple and economical process for producing polymeric nettings.

### SUMMARY

In one aspect, the present disclosure describes a netting comprising an array of (typically adjacent) polymeric strands, wherein the polymeric strands are periodically joined together at bond regions throughout the array, and wherein at least a plurality (i.e., at least two) of the polymeric strands have a core of a first polymeric material and a sheath of a second, different polymeric material. In some embodiments, at least some of the cores have at least two (in some embodiments at least 3 or more) sheaths. In some embodiments, the plurality of strands include alternating first and second polymeric strands. In some embodiments, all the polymeric strands will have a core/sheath arrangement. In some embodiments, for example, strands with a core/sheath arrangement alternate with strands made of a single material (i.e., not a core/sheath construction).

In another aspect, the present disclosure describes an extrusion die having at least first and second cavities, a first passageway extending from the first cavity into a vestibule defining a dispensing orifice, and second and third passageways extending from the second cavity to the vestibule, each on opposite sides of the first passageway, and each having a dimension larger than the first passageway at the point where the first passageway enters the vestibule. This extrusion die can be used to form a core/sheath strand.

In another aspect, the present disclosure describes an extrusion die comprising a plurality of shims positioned adjacent to one another, the shims together defining at least a first cavity and a second cavity, and a dispensing surface, wherein the dispensing surface has an array of dispensing orifices defined by an array of vestibules, wherein the plurality of shims comprises a plurality of a repeating sequence of shims, wherein the repeating sequence comprises: shims that provide a fluid passageway between the first cavity and one of the vestibules, shims that provide a second passageway extending from the second cavity to the same vestibule, and shims that provide a third passageway extending from the second cavity to the same vestibule, wherein each of the second and third passageways is on opposite sides of the first passageway, and each of the second and third passageways has a dimension larger than the first passageway at the point where the first passageway enters the vestibule. This extrusion die can be used to form multiple core/sheath strands simultaneously.

In another aspect, the present disclosure describes an extrusion die comprising a plurality of shims positioned adjacent to one another, the shims together defining at least a first cavity and a second cavity, and a dispensing surface, wherein the dispensing surface has an first array of first dispensing orifices defined by an array of vestibules, and a second array of second dispensing orifices, wherein the plurality of shims comprises a plurality of a repeating sequence of shims, wherein the repeating sequence comprises shims that provide a fluid passageway between the first cavity and one of the vestibules, shims that provide a second passageway extending from the second cavity to the same vestibule, and shims that provide a third passageway extending from the second cavity to the same vestibule, wherein each of the second and third passageways is on opposite sides of the first passageway, and each of the second and third passageways has a dimension larger than the first passageway at the point where the first passageway enters the vestibule, and wherein the repeating sequence further comprises shims that provide a passageway from a cavity to one of the second dispensing orifices. This extrusion die can be used to form multiple core/sheath strands simultaneously.

If an extrusion die described herein is operated so as to dispense core/sheath polymeric strands from the first dispensing orifices at a first strand speed while simultaneously dispensing second polymeric strands from the second dispensing orifices at a second strand speed, and the first and second strand speeds are different from each other by at least 2 (in some embodiments, in a range from 2 to 6, or even 2 to 4) times, (typically, the arrays of orifices are alternating), a netting can be formed. In some embodiments, the shims that provide a passageway from a cavity to one of the second dispensing orifices provide a passageway from either the first or the second cavity. In other embodiments, the shims that provide a passageway from a cavity to the second dispensing orifices provide a passageway from a third cavity entirely. In other embodiments, the shims that provide a passageway from a cavity to the second dispensing orifices provide a passageway from a third cavity and a fourth cavity, and form the second strand in the form of a core/sheath strand. It is further possible to feed the second dispensing orifices from the first and second cavity, to form netting composed of alternating and similar core/sheath strands.

In another aspect, the present disclosure describes an extrusion die comprising a plurality of shims positioned adjacent to one another, the shims together defining at least a first cavity and a second cavity and a dispensing surface, wherein the dispensing surface has at least one net-forming zone and at least one ribbon-forming zone, wherein the dispensing surface within the net-forming zone has a zone has an first array of first dispensing orifices defined by an array of vestibules, and a second array of second dispensing orifices, wherein the plurality of shims comprises a plurality of a repeating sequence of shims, wherein the repeating sequence comprises shims that provide a fluid passageway between the first cavity and one of the vestibules, shims that provide a second passageway extending from the second cavity to the same vestibule, and shims that provide a third passageway extending from the second cavity to the same vestibule, wherein each of the second and third passageways is on opposite sides of the first passageway, and each of the second and third passageways has a dimension larger than the first passageway at the point where the first passageway enters the vestibule and wherein the repeating sequence further comprises shims that provide a passageway from a cavity to the array of second dispensing orifices. In some embodiments, each of the dispensing orifices of the first and the second arrays have a width, and each of the dispensing orifices of the first and the second arrays are separated by up to 2 times the width of the respective dispensing orifice. The ribbon-forming zone conveniently has a dispensing slot, and that dispensing slot may be fed from the first cavity, the second cavity, and/or a third cavity altogether to as to form a ribbon attached to the netting.

In another aspect, the present disclosure describes a method of making strands described herein, the method comprising:

providing an extrusion die comprising a plurality of shims positioned adjacent to one another, the shims together defining at least a first cavity and a second cavity, and a dispensing surface, wherein the dispensing surface has an array of dispensing orifices defined by an array of vestibules, wherein the plurality of shims comprises a plurality of a repeating sequence of shims, wherein the repeating sequence comprises: shims that provide a fluid passageway between the first cavity and one of the vestibules, shims that provide a second passageway extending from the second cavity to the same vestibule, and shims that provide a third passageway extending from the second cavity to the same vestibule, wherein each of the second and third passageways is on opposite sides of the first passageway, and each of the second and third passageways has a dimension larger than the first passageway at the point where the first passageway enters the vestibule; and

dispensing the polymeric strands from the array of dispensing orifices.

In another aspect, the present disclosure describes a method of making netting described herein, the method comprising:

providing an extrusion die comprising a plurality of shims positioned adjacent to one another, the shims together defining at least a first cavity and a second cavity, and a dispensing surface, wherein the dispensing surface has an array of dispensing orifices defined by an array of vestibules, (typically, alternating with an array of second orifices), wherein the plurality of shims comprises a plurality of a repeating sequence of shims, wherein the repeating sequence comprises: shims that provide a fluid passageway between the first cavity and one of the vestibules, shims that provide a second passageway extending from the second cavity to the same vestibule, and shims that provide a third passageway extending from the second cavity to the same vestibule, wherein each of the second and third passageways is on opposite sides of the first passageway, and each of the second and third passageways has a dimension larger than the first passageway at the point where the first passageway enters the vestibule; and

dispensing first polymeric strands from first dispensing orifices of the array at a first strand speed while simultaneously dispensing second polymeric strands from second dispensing orifices of the array at a second strand speed, wherein the first strand speed is at least 2 (in some embodiments, in a range from 2 to 6, or even 2 to 4) times the second strand speed to provide the netting.

In another aspect, the present disclosure describes a method of making strands described herein, the method comprising:

providing an extrusion die comprising a plurality of shims positioned adjacent to one another, the shims together defining at least a first cavity and a second cavity, and a dispensing surface, wherein the dispensing surface has an first array of first dispensing orifices defined by an array of vestibules, and a second array of second dispensing orifices, wherein the plurality of shims comprises a plurality of a repeating sequence of shims, wherein the repeating sequence comprises shims that provide a fluid passageway between the first cavity and one of the vestibules, shims that provide a second passageway extending from the second cavity to the same vestibule, and shims that provide a third passageway extending from the second cavity to the same vestibule, wherein each of the second and third passageways is on opposite sides of the first passageway, and each of the second and third passageways has a dimension larger than the first passageway at the point where the first passageway enters the vestibule, and wherein the repeating sequence further comprises shims that provide a passageway from a cavity to one of the second dispensing orifices; and

dispensing the polymeric strands from the arrays of dispensing orifices.

In another aspect, the present disclosure describes a method of making netting described herein, the method comprising:

providing an extrusion die comprising a plurality of shims positioned adjacent to one another, the shims together defining at least a first cavity and a second cavity, and a dispensing surface, wherein the dispensing surface has an first array of first dispensing orifices defined by an array of vestibules, and a second array of second dispensing orifices (typically, alternating with), wherein the plurality of shims comprises a plurality of a repeating sequence of shims, wherein the repeating sequence comprises shims that provide a fluid passageway between the first cavity and one of the vestibules, shims that provide a second passageway extending from the second cavity to the same vestibule, and shims that provide a third passageway extending from the second cavity to the same vestibule, wherein each of the second and third passageways is on opposite sides of the first passageway, and each of the second and third passageways has a dimension larger than the first passageway at the point where the first passageway enters the vestibule, and wherein the repeating sequence further comprises shims that provide a passageway from a cavity to one of the second dispensing orifices; and

dispensing first polymeric strands from the first dispensing orifices at a first strand speed while simultaneously dispensing second polymeric strands from the second dispensing orifices at a second strand speed, wherein the first strand speed is at least 2 (in some embodiments, in a range from 2 to 6, or even 2 to 4) times the second strand speed to provide the netting.

Nettings described herein have a variety of uses, including wound care and other medical applications (e.g., elastic bandage-like material, surface layer for surgical drapes and gowns, and cast padding), tapes (including for medical applications), filtration, absorbent articles (e.g., diapers and feminine hygiene products) (e.g., as a layer(s) within the articles and/or as part of an attachment system for the articles), pest control articles (e.g., mosquito nettings), geotextile applications (e.g., erosion control textiles), water/vapor management in clothing, reinforcement for nonwoven articles (e.g., paper towels), self bulking articles (e.g., for packaging) where the netting thickness is increased by stretching nettings with first strands have average first yield strength, and wherein the second strands have an average second yield strength that is different (e.g., at least 10 percent different) than the first yield strength, floor coverings (e.g., rugs and temporary mats), grip supports for tools, athletic articles, and pattern coated adhesives.

Strands described herein have a variety of uses including fishing lines, and elastic versions for diapers.

### BRIEF DESCRIPTION OF THE DRAWINGS

FIG. 1 is a plan view of an exemplary shim suited to form a repeating sequence of shims capable of forming a netting having strands of a single material and strands formed of two materials in a sheath/core arrangement;

FIG. 2 is a plan view of another exemplary shim suited to form a repeating sequence of shims capable of forming a netting having strands of a single material and strands formed of two materials in a sheath/core arrangement;

FIG. 3 is a plan view of another exemplary shim suited to form a repeating sequence of shims capable of forming a netting having strands of a single material and strands formed of two materials in a sheath/core arrangement;

FIG. 4 is a plan view of another exemplary shim suited to form a repeating sequence of shims capable of forming a netting having strands of a single material and strands formed of two materials in a sheath/core arrangement;

FIG. 5 is a plan view of another exemplary shim suited to form a repeating sequence of shims capable of forming a netting having strands of a single material and strands formed of two materials in a sheath/core arrangement;

FIG. 6 is an exploded perspective assembly drawing of a repeating sequence of shims employing the shims of FIGS. 1-5;

FIG. 7 is a detail view of the section referenced as “detail 7” in FIG. 6;

FIG. 8 is a perspective view of the repeating sequence of shims of FIG. 7 in its assembled state;

FIG. 9 is an exploded perspective view of an exemplary mount suitable for an extrusion die composed of multiple repeats of the repeating sequence of shims of FIG. 6;

FIG. 10 is a perspective view of the mount of FIG. 9 in an assembled state;

FIG. 11 is a perspective view of an exemplary netting described herein having a set of strands formed of a single material and a set of strands formed with a core/sheath arrangement;

FIG. 12 is a perspective view of an exemplary article described herein having ribbon regions and netting regions;

FIG. 13 is a perspective view of an exemplary netting described herein having a set of strands formed of a single material and a set of strands formed with a core/sheath arrangement, bonded to a substrate; and

FIG. 14 is a digital optical image at 10× of an exemplary netting described herein.

### DETAILED DESCRIPTION

In some embodiments, the plurality of shims comprises a plurality of at least one repeating sequence of shims that includes shims that provide a passageway between a first and second cavity and the first dispensing orifices. In some of these embodiments, there will be additional shims that provide a passageway between the first and/or the second cavity, and/or a third (or more) cavity and second dispensing orifices. Typically, not all of the shims of dies described herein have passageways, as some may be spacer shims that provide no passageway between any cavity and a dispensing orifice. In some embodiments, there is a repeating sequence that further comprises at least one spacer shim. The number of shims providing passageway to the first dispensing orifices may be equal or unequal to the number of shims providing a passageway to the second dispensing orifices.

In some embodiments, the first dispensing orifices and the second dispensing orifices are collinear. In some embodiments, the first dispensing orifices are collinear, and the second dispensing orifices are also collinear but offset from and not collinear with the first dispensing orifices.

In some embodiments, extrusion dies described herein include a pair of end blocks for supporting the plurality of shims. In these embodiments it may be convenient for one or all of the shims to each have one or more through-holes for the passage of connectors between the pair of end blocks. Bolts disposed within such through-holes are one convenient approach for assembling the shims to the end blocks, although the ordinary artisan may perceive other alternatives for assembling the extrusion die. In some embodiments, the at least one end block has an inlet port for introduction of fluid material into one or both of the cavities.

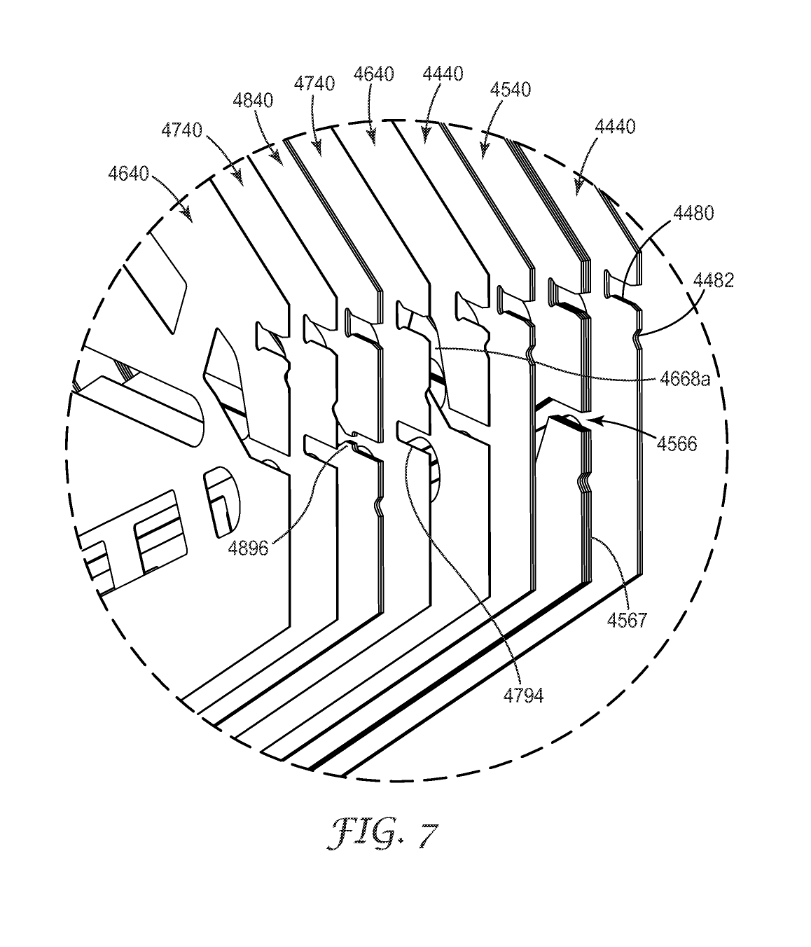

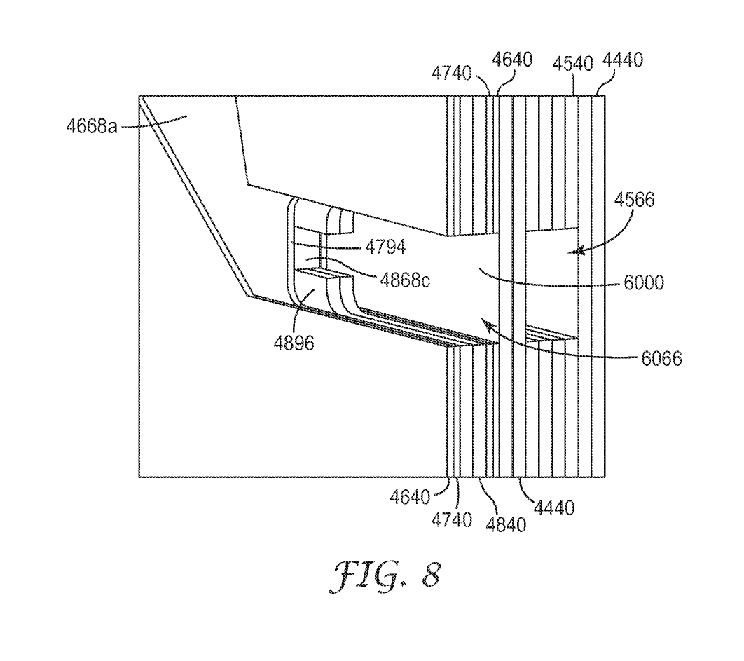

In some embodiments, the shims will be assembled according to a plan that provides a repeating sequence of shims of diverse types. The repeating sequence can have diverse numbers of shims per repeat. For a first example, a fourteen-shim repeating sequence that when properly provided with molten polymer forms a netting with a single-material strand alternating with a core/sheath strand is described below in connection with FIG. 7.

Exemplary passageway cross-sectional shapes include square and rectangular shapes. The shape of the passageways within, for example, a repeating sequence of shims, may be identical or different. For example, in some embodiments, the shims that provide a passageway between the first cavity and a first dispensing orifice might have a flow restriction compared to the shims that provide a conduit between the second cavity and a second dispensing orifice. The width of the distal opening within, for example, a repeating sequence of shims, may be identical or different. For example, the portion of the distal opening provided by the shims that provide a conduit between the first cavity and a first dispensing orifice could be narrower than the portion of the distal opening provided by the shims that provide a conduit between the second cavity and a second dispensing orifice.

In some embodiments, the assembled shims (conveniently bolted between the end blocks) further comprise a manifold body for supporting the shims. The manifold body has at least one (or more (e.g., two or three, four, or more)) manifold therein, the manifold having an outlet. An expansion seal (e.g., made of copper or alloys thereof) is disposed so as to seal the manifold body and the shims, such that the expansion seal defines a portion of at least one of the cavities (in some embodiments, a portion of both the first and second cavities), and such that the expansion seal allows a conduit between the manifold and the cavity.

In some embodiments, with respect to extrusion dies described herein, each of the dispensing orifices of the first and the second arrays have a width, and each of the dispensing orifices of the first and the second arrays are separated by up to 2 times the width of the respective dispensing orifice.

Typically, the passageway between cavity and dispensing orifice is up to 5 mm in length. Sometimes the first array of fluid passageways has greater fluid restriction than the second array of fluid passageways.

In some embodiments, for extrusion dies described herein, each of the dispensing orifices of the first and the second arrays have a cross sectional area, and each of the dispensing orifices of the first arrays has an area different than that of the second array.

Typically, the spacing between orifices is up to 2 times the width of the orifice. The spacing between orifices is greater than the resultant diameter of the strand after extrusion. This diameter is commonly called die swell. This spacing between orifices is greater than the resultant diameter of the strand after extrusion leads to the strands repeatedly colliding with each other to form the repeating bonds of the netting. If the spacing between orifices is too great the strands will not collide with each other and will not form the netting.

The shims for dies described herein typically have thicknesses in the range from 50 micrometers to 125 micrometers, although thicknesses outside of this range may also be useful. Typically, the fluid passageways have thicknesses in a range from 50 micrometers to 750 micrometers, and lengths less than 5 mm (with generally a preference for smaller lengths for decreasingly smaller passageway thicknesses), although thicknesses and lengths outside of these ranges may also be useful. For large diameter fluid passageways several smaller thickness shims may be stacked together, or single shims of the desired passageway width may be used.

The shims are tightly compressed to prevent gaps between the shims and polymer leakage. For example, 12 mm (0.5 inch) diameter bolts are typically used and tightened, at the extrusion temperature, to their recommended torque rating. Also, the shims are aligned to provide uniform extrusion out the extrusion orifice, as misalignment can lead to strands extruding at an angle out of the die which inhibits desired bonding of the net. To aid in alignment, an alignment key can be cut into the shims. Also, a vibrating table can be useful to provide a smooth surface alignment of the extrusion tip.

The size (same or different) of the strands can be adjusted, for example, by the composition of the extruded polymers, velocity of the extruded strands, and/or the orifice design (e.g., cross sectional area (e.g., height and/or width of the orifices)). For example, a first polymer orifice that is 3 times greater in area than the second polymer orifice can generate a netting with equal strand sizes while meeting the velocity difference between adjacent strands.

In general, it has been observed that the rate of strand bonding is proportional to the extrusion speed of the faster strand. Further, it has been observed that this bonding rate can be increased, for example, by increasing the polymer flow rate for a given orifice size, or by decreasing the orifice area for a given polymer flow rate. It has also been observed that the distance between bonds (i.e., strand pitch) is inversely proportional to the rate of strand bonding, and proportional to the speed that the netting is drawn away from the die. Thus, it is believed that the bond pitch and the netting basis weight can be independently controlled by design of the orifice cross sectional area, the takeaway speed, and the extrusion rate of the polymer. For example, relatively high basis weight nettings, with a relatively short bond pitch can be made by extruding at a relatively high polymer flow rate, with a relatively low netting takeaway speed, using a die with a relatively small strand orifice area.

Some of the embodiments of dies according to the present disclosure have an array of vestibules in which a core/sheath strand is formed. As will be discussed with more particularity below in connection with FIG. 8, such dies can include a plurality of shims comprising a plurality of a repeating sequence of shims. Such a repeating sequence can include shims that provide a fluid passageway between the first cavity and one of the vestibules, shims that provide a second passageway extending from the second cavity to the same vestibule, and shims that provide a third passageway extending from the second cavity to the same vestibule, wherein each of the second and third passageways are on opposite sides of the first passageway, and each of the second and third passageways has a dimension larger than the first passageway at the point where the first passageway enters the vestibule. This allows the flows from the second and third passageways to encapsulate the material entering the vestibule from the first passageway. Obtaining good encapsulation of the core material entering from the first passageway depends in part on the melt viscosity of the sheath material. In general, lower melt viscosity of the sheath material improves the encapsulation of the core material. Further, the encapsulation depends in part on the degree to which the second and third passageways have a dimension larger than the first passageway at the point when they enter the vestibule. In general, increasing the degree by which that dimension is larger for the second and third passageways relative to same dimension for the first passageway will improve the encapsulation of the core material. Good results are obtained when the dimensions of the passageways and pressures within the cavities are manipulated so that the flow speed of the sheath materials within the vestibule and the flow speed of the core materials within the vestibule are close to one another.

Typically, the polymeric strands are extruded in the direction of gravity. This enables collinear strands to collide with each other before becoming out of alignment with each other. In some embodiments, it is desirable to extrude the strands horizontally, especially when the extrusion orifices of the first and second polymer are not collinear with each other.

In practicing methods described herein, the polymeric materials might be solidified simply by cooling. This can be conveniently accomplished passively by ambient air, or actively by, for example, quenching the extruded first and second polymeric materials on a chilled surface (e.g., a chilled roll). In some embodiments, the first and/or second polymeric materials are low molecular weight polymers that need to be cross-linked to be solidified, which can be done, for example, by electromagnetic or particle radiation. In some embodiments, it is desirable to maximize the time to quenching to increase the bond strength.

Optionally, it may be desirable to stretch the as-made netting. Stretching may orientate the strands, and has been observed to increase the tensile strength properties of the netting. Stretching may also reduce the overall strand size, which may be desirable for applications which benefit from a relatively low basis weight. As an additional example, if the materials and the degree of stretch, are chosen correctly, the stretch can cause some of the strands to yield while others do not, tending to form loft (e.g., the loft may be created because of the length difference between adjacent bonded netting strands or by curling of the bonds due to the yield properties of the strands forming the bond). The attribute can be useful for packaging applications where the material can be shipped to package assembly in a relatively dense form, and then lofted, on location. The loftiness attribute can also be useful as the loop for hook and loop attachment systems, wherein the loft created with strands enables hook attachment to the netting strands. As a second additional example, if the materials of the first and second sets of strands are of different strength, cross-machine direction stretching can cause one strand to stretch and the second set of strand to not stretch. This can be useful to create for example, elastic strands which provide machine direction elasticity, which are connected to small, oriented strands, which purpose is to hold the elastic strands in place. In some embodiments, netting could be made with cross-direction elasticity with relatively small strands that are elastic, connected to relatively large strands that are inelastic.

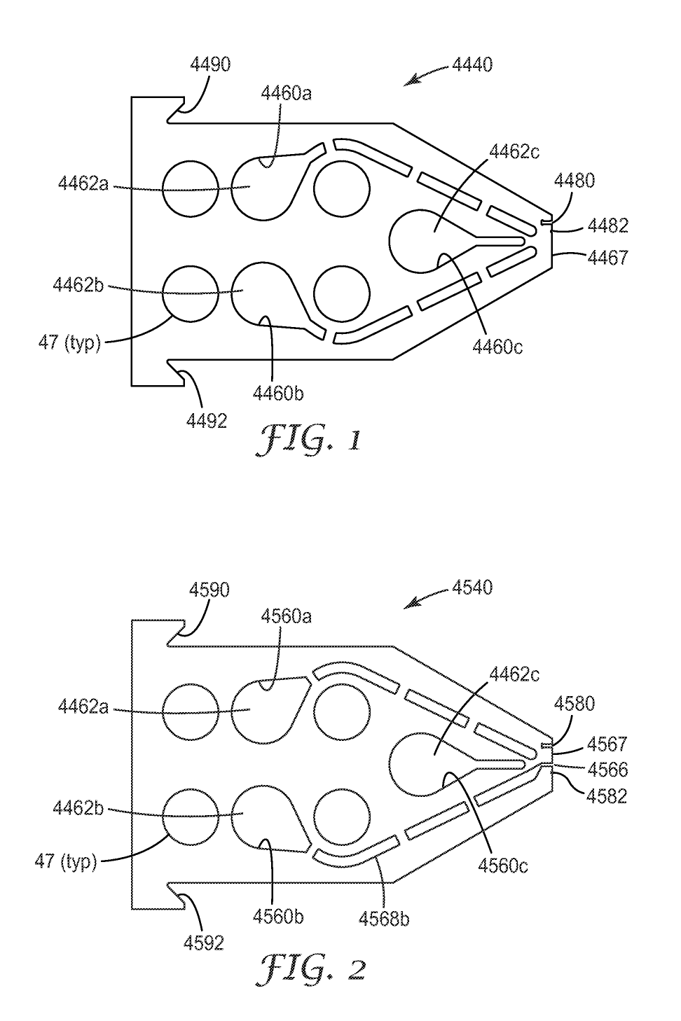

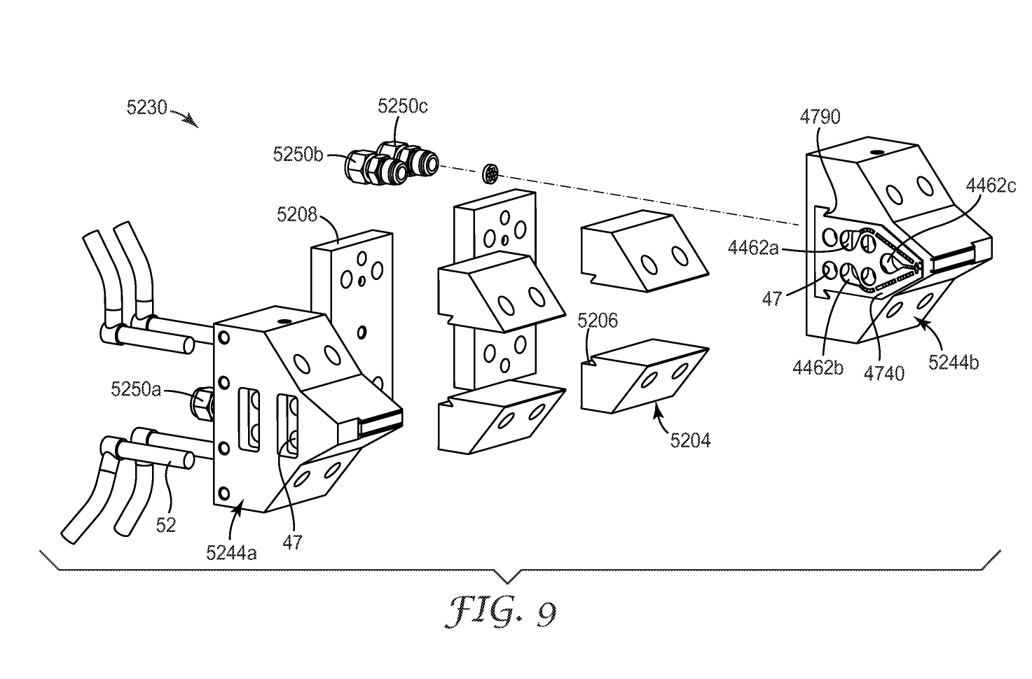

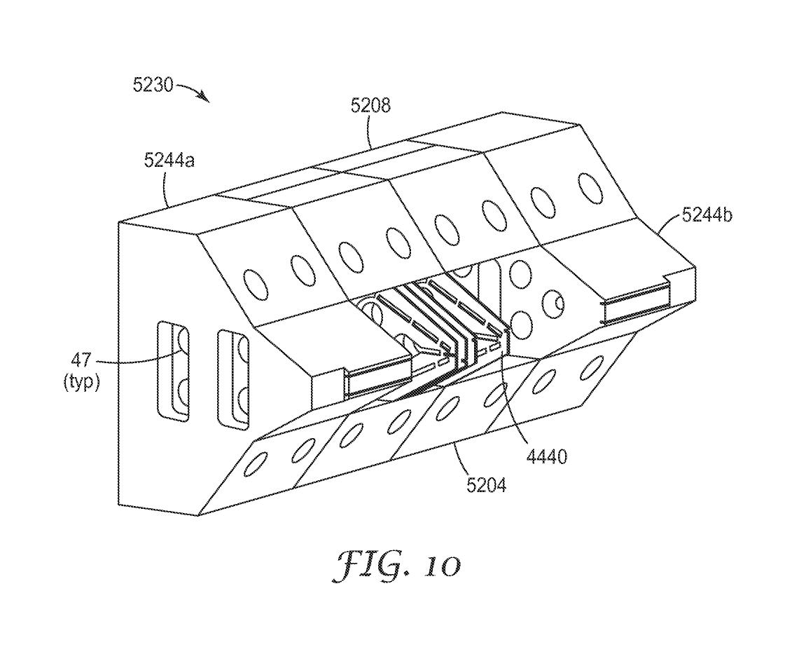

Dies and methods described herein can be used to form netting where polymeric strands are formed of two different materials in a sheath/core arrangement. FIGS. 1-5 illustrate exemplary shims useful for assembling an extrusion die capable of producing a netting where one of the strands is of sheath/core arrangement and the other strand is a single material. FIG. 6 is an exploded perspective assembly illustration of an exemplary repeating sequence employing those shims. FIG. 8 is a detail perspective view of the exemplary dispensing surface associated with the repeating sequence of FIG. 6. FIG. 8 is a perspective view of the repeating sequence of shims of FIG. 7 in its assembled state. FIG. 9 is an exploded perspective view of a mount suitable for an extrusion die composed of multiple repeats of the repeating sequence of shims of FIG. 6. FIG. 10 shows the mount of FIG. 9 in an assembled state.

Referring now to FIG. 1, a plan view of shim 4440 from FIG. 6 is illustrated Shim 4440 has first aperture, 4460a, second aperture 4460b, and third aperture 4460c. When shim 4440 is assembled with others as shown in FIG. 6, aperture 4460a will help define first cavity 4462a, aperture 4460b will help define second cavity 4462b, and aperture 4460c will help define third cavity 4462c. As will be discussed with more particularity below, molten polymer in cavities 4462a and 4462c can be extruded in a strand with a sheath/core arrangement, and molten polymer in cavity 4462b can be extruded as a simple strand so as to form netting described herein.

Shim 4440 has several holes 47 to allow the passage of, for example, bolts to hold shim 4440 and others to be described below into an assembly. Shim 4440 has dispensing surface 4467, and in this particular embodiment, dispensing surface 4467 has indexing groove 4480 which can receive an appropriately shaped key to ease assembling diverse shims into a die. The shim may also have identification notch 4482 to help verify that the die has been assembled in the desired manner. This embodiment has shoulders 4490 and 4492, which these can assist in mounting the assembled die in a manner which will be made clear below in connection with FIG. 9.

Referring now to FIG. 2, a plan view of a shim 4540 is illustrated Shim 4540 has first aperture 4560a, second aperture 4560b, and third aperture 4560c. When shim 4540 is assembled with others as shown in FIG. 6, aperture 4560a will help define first cavity 4462a, aperture 4560b will help define second cavity 4462b, and aperture 4560c will help define third cavity 4462c. Analogous to shim 4440, shim 4540 has dispensing surface 4567, and in this particular embodiment, dispensing surface 4567 has indexing groove 4580, identification notch 4582, and shoulders 4590 and 4592. It might seem that there is no path from cavity 4462b to dispensing orifice 4566, via, for example, passageway 4568b, but this is an illusion—the flow has a route in the perpendicular-to-the-plane-of-the-drawing dimension when the repeating sequence of FIG. 6 is completely assembled.

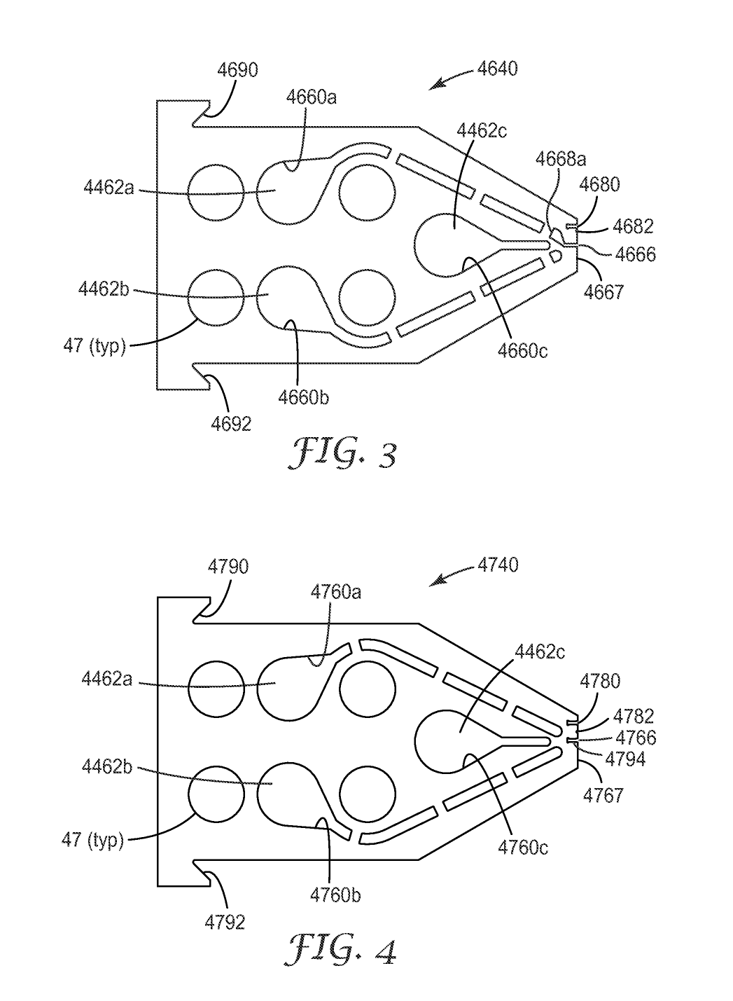

Referring now to FIG. 3, a plan view of shim 4640 is illustrated Shim 4640 has first aperture 4660a, second aperture 4660b, and third aperture 4660c. When shim 4640 is assembled with others as shown in FIG. 6, aperture 4660a will help define first cavity 4462a, aperture 4660b will help define second cavity 4462b, and aperture 4660c will help define third cavity 4462c. Analogous to shim 4440, shim 4640 has dispensing surface 4667, and in this particular embodiment, dispensing surface 4667 has indexing groove 4680, an identification notch 4682, and shoulders 4690 and 4692. It might seem that there is no path from cavity 4462a to dispensing orifice 4666, via, for example, passageway 4668a, but this is an illusion—the flow has a route in the perpendicular-to-the-plane-of-the-drawing dimension when the repeating sequence of FIG. 6 is completely assembled.

Referring now to FIG. 4, a plan view of shim 4740 is illustrated. Shim 4740 has first aperture 4760a, second aperture 4760b, and third aperture 4760c. When shim 4740 is assembled with others as shown in FIG. 6, aperture 4760a will help define first cavity 4462a, aperture 4760b will help define second cavity 4462b, and aperture 4760c will help define third cavity 4462c. Analogous to shim 4440, shim 4740 has dispensing surface 4767, and in this particular embodiment, dispensing surface 4767 has indexing groove 4780, identification notch 4782, and shoulders 4790 and 4792. Shim 4740 has dispensing orifice 4766, but it will be noted that this shim has no connection between dispensing orifice 4766 and any of the cavities 4462a, 4462b, or 4462c. As will be appreciated more completely in the discussion below, blind recess 4794 behind dispensing orifice 4766 helps shape the flow of material from cavity 4462a into a sheath around the core provided by material emerging from shim 4840.

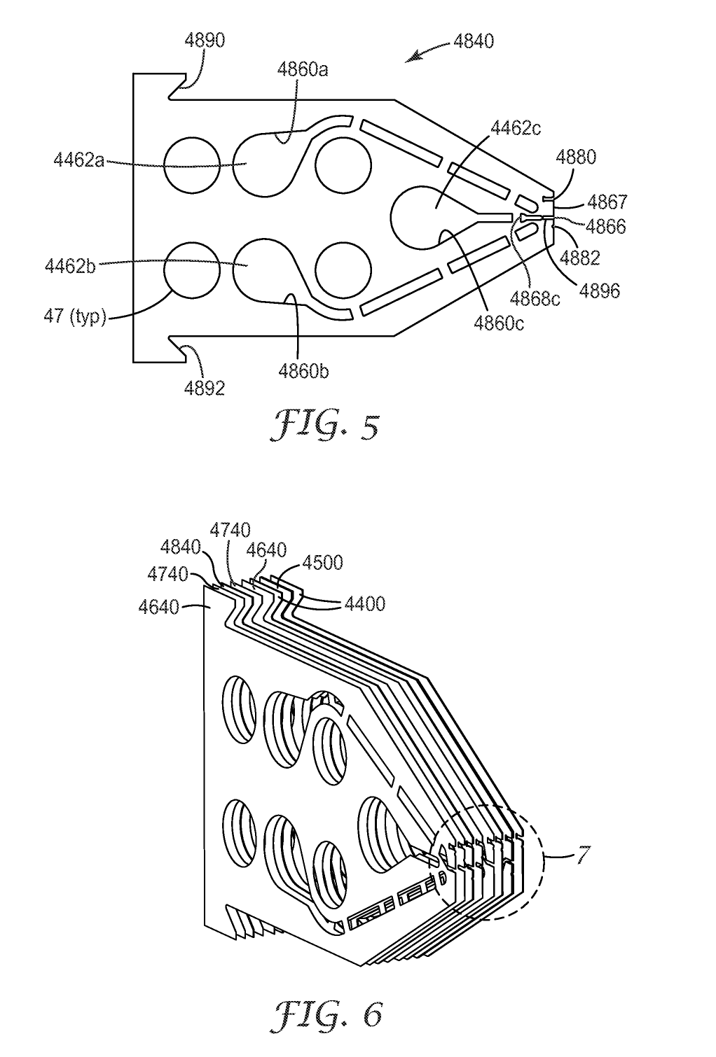

Referring now to FIG. 5, a plan view of shim 4840 is illustrated. Shim 4840 has first aperture, 4860a, second aperture 4860b, and third aperture 4860c. When shim 4840 is assembled with others as shown in FIG. 6, aperture 4860a will help define first cavity 4462a, aperture 4860b will help define second cavity 4462b, and aperture 4860c will help define third cavity 4462c. Analogous to shim 4440, shim 4840 has dispensing surface 4867, and in this particular embodiment, dispensing surface 4867 has indexing groove 4880, identification notch 4882, and shoulders 4890 and 4892. It might seem that there is no path from cavity 4462c to dispensing orifice 4866, via, for example, passageway 4868c, but this is an illusion—the flow has a route in the perpendicular-to-the-plane-of-the-drawing dimension when the repeating sequence of FIG. 6 is completely assembled. It will be noted that passageway 4868c includes constriction 4896 upstream from dispensing orifice 4866. It will appreciated in connection with FIG. 8 that constriction 4896 helps the sheath to completely surround the core of the emerging fiber.

Referring now to FIG. 6, an exploded perspective assembly drawing of a repeating sequence of shims employing the shims of FIGS. 1-5 is illustrated. Referring now to FIG. 7, a detail view of the section referenced as “detail 7” in FIG. 6 is illustrated. In the particular illustrated embodiment, the repeating sequence includes, from right to left as the drawing is oriented, two instances of shim 4440, four instances of shim 4540, two instances of shim 4440, one instance of shim 4640, one instance of shim 4740, two instances of shim 4840, one instance of shim 4740, and one instance of shim 4640.

Referring now to FIG. 8, the repeating sequence of shims of FIG. 7 is illustrated in its assembled state. In this view, it is easier to appreciate how the single material strand emerges from the egress provided by four dispensing orifices 4566 of the four instances of shim 4540. It is also easier to appreciate how shims 4640, 4740, and 4840 together form vestibule 6000 leading towards dispensing orifice 6066. The presence of constriction 4896 on the two instances of shim 4840 allows the inflows along passageways 4668a to have a dimension larger than passageway 4868c at the point where passageway 4868c enters the vestibule 6000. Blind recesses 4794 on the two instances of shim 4740 cooperate to allow the inflows from along passages 4668a on the two instances of shim 4640 to envelop the inflow from the passages 4868c on the two instances of shim 4840, resulting in a sheath/core strand. In some embodiments, a singular thicker shim could be to provide four dispensing orifices 4566.

Referring now to FIG. 9, an exploded perspective view of a mount 5230 suitable for an extrusion die composed of multiple repeats of the repeating sequence of shims of FIG. 6 is illustrated. Mount 5230 is particularly adapted to use shims 4440, 4540, 4640, 4740 and 4840 is shown in FIGS. 1 through 8. However for visual clarity, only a single instance of shim 4740 is shown in FIG. 9. The multiple repeats of the repeating sequence of shims of FIG. 6 are compressed between two end blocks 5244a and 5244b. Conveniently, through bolts can be used to assemble the shims to the end blocks 5244a and 5244b, passing through holes 47 in shims 4740 et al.

In this embodiment, inlet fittings 5250a and 5250b, and 5250c provide a flow path for three streams of molten polymer through end blocks 5244a and 5244b to cavities 4462a, 4462b, and 4462c. Compression blocks 5204 have a notch 5206 that conveniently engages the shoulders on the shims (e.g., 4790 and 4792 on 4740). When mount 5230 is completely assembled, compression blocks 5204 are attached by, e.g. machine bolts to backplates 5208. Holes are conveniently provided in the assembly for the insertion of cartridge heaters 52.

Referring now to FIG. 10, a perspective view of mount 5230 of FIG. 9 is illustrated in a partially assembled state. A few shims (e.g., 4440) are in their assembled positions to show how they fit within mount 5230, but most of the shims that would make up an assembled die have been omitted for visual clarity.

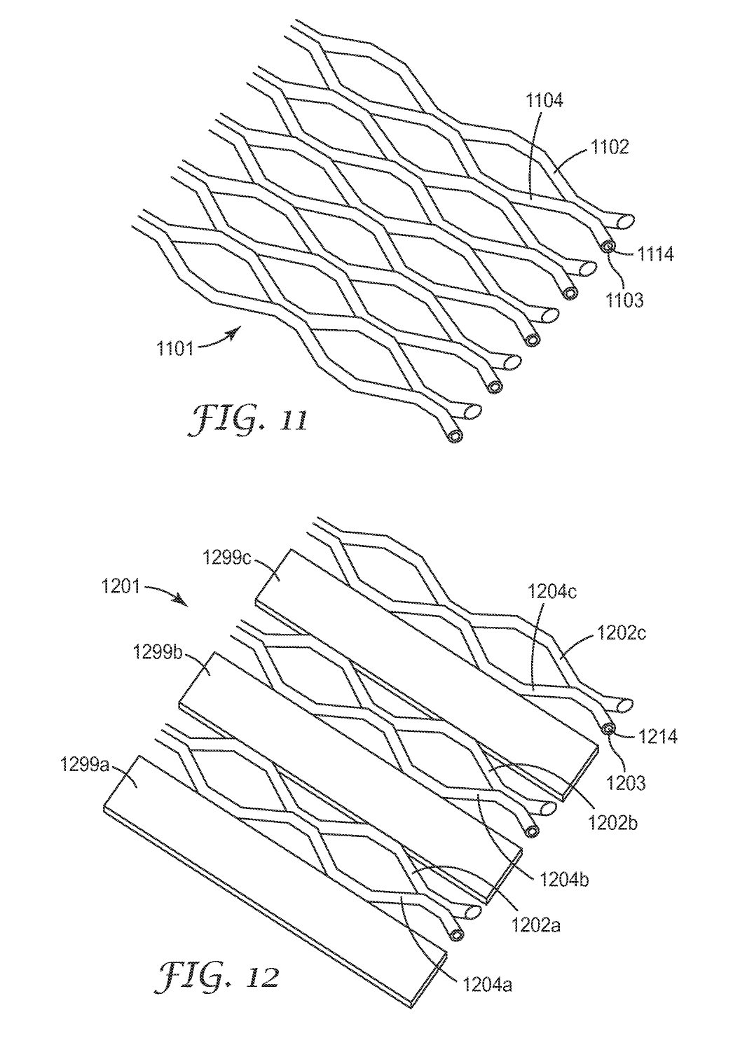

Referring now to FIG. 11, a perspective view of exemplary netting 1101 described herein is illustrated. Netting 1101 includes first strands 1102 formed of a single material and second strands 1104 which each have core 1114 surrounded by sheath 1103.

Referring now to FIG. 12, a perspective view of exemplary article described herein 1201 is illustrated. The present disclosure also provides an article comprising one or more nettings as described herein, with a ribbon region disposed there between. Typically, the netting and ribbon region are integral. The present disclosure also provides an article comprising netting described herein disposed between two ribbon regions. Typically, the netting and ribbon regions are integral. An example is shown in FIG. 12, where netting comprising core/sheath strand 1204a and solid strand 1202a is disposed between and connected to ribbon regions 1299a and 1299b. Netting comprising core/sheath strand 1204b and solid strand 1202b is disposed between and connected to ribbon regions 1299b and 1299c. Netting comprising core/sheath strand 1204c and solid strand 1202c is adjacent to and connected to ribbon region 1299c. Core/sheath strands 1204a, 1204b, and 1204c include core 1214 surrounded by sheath 1203. Ribbon regions 1299a, 1299b, and 1299c can be formed by constructing a portion of the die with a repeating sequence of shims all connected to a single one of the cavities.

FIG. 13 is a perspective view of exemplary article described herein 1301 comprising a netting having strands 1302 formed of a single material and strands 1304 formed with a core/sheath arrangement, the netting bonded to substrate 1390. Core/sheath strands 1304 include core 1314 surrounded by sheath 1303. The depicted netting is periodically bonded to substrate 1390 at a series of bond points 1320 in a bond line 1392. Substrate 1390 may be, for example, a polymeric film or a nonwoven fabric, depending on the end use intended for article 1301. Bond lines 1392 can be formed by heat or ultrasonic welding, the latter can be accomplished, for example, with a sonic bonder such as that available under the trade designation “0 MHZ BRANSON 2000AED” from Branson Ultrasonics Corporation, Danbury, Conn.

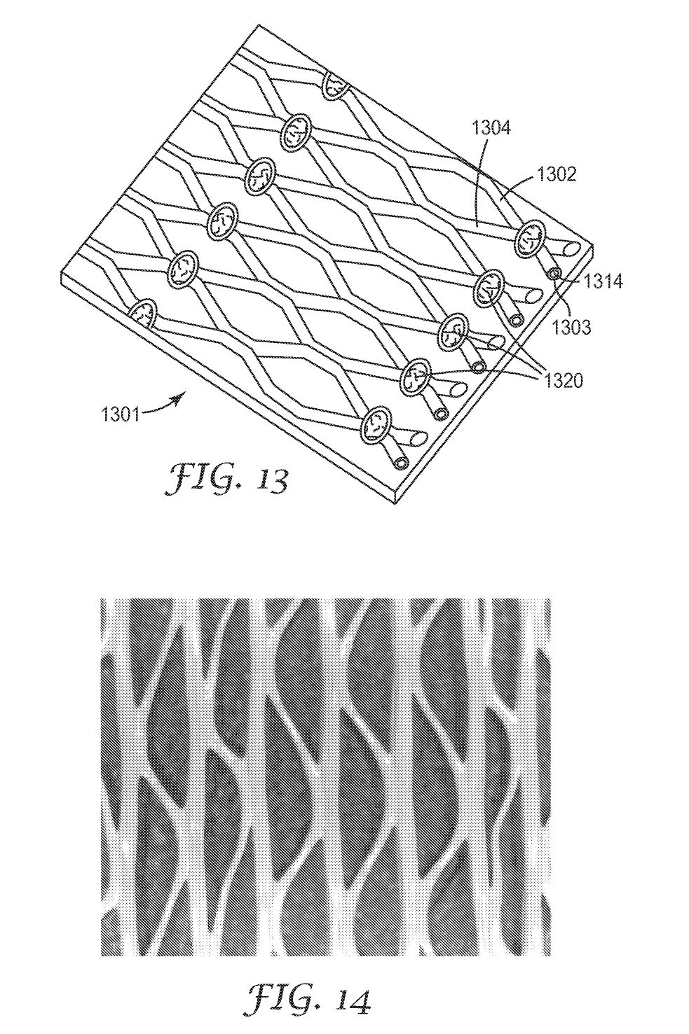

FIG. 14 is a digital optical image at 10× of an exemplary netting described herein (and made as described in the Example, below) 1401. Netting 1401 includes first strands of solid material 1402 and second strands having a core/sheath arrangement 1404.

Portions of the exteriors of the first and second strands bond together at the bond regions. In methods described herein for making nettings described herein, the bonding occurs in a relatively short period of time (typically less than 1 second). The bond regions, as well as the strands typically cool through air and natural convection and/or radiation. In selecting polymers for the strands, in some embodiments, it may be desirable to select polymers of bonding strands that have dipole interactions (or H-bonds) or covalent bonds. Bonding between strands has been observed to be improved by increasing the time that the strands are molten to enable more interaction between polymers. Bonding of polymers has generally been observed to be improved by reducing the molecular weight of at least one polymer and or introducing an additional co-monomer to improve polymer interaction and/or reduce the rate or amount of crystallization. In some embodiments, the bond strength is greater than the strength of the strands forming the bond. In some embodiments, it may be desirable for the bonds to break and thus the bonds will be weaker than the strands.

Suitable polymeric materials for extrusion from dies described herein, methods described herein, and for composite layers described herein include thermoplastic resins comprising polyolefins (e.g., polypropylene and polyethylene), polyvinyl chloride, polystyrene, nylons, polyesters (e.g., polyethylene terephthalate) and copolymers and blends thereof. Suitable polymeric materials for extrusion from dies described herein, methods described herein, and for composite layers described herein also include elastomeric materials (e.g., ABA block copolymers, polyurethanes, polyolefin elastomers, polyurethane elastomers, metallocene polyolefin elastomers, polyamide elastomers, ethylene vinyl acetate elastomers, and polyester elastomers). Exemplary adhesives for extrusion from dies described herein, methods described herein, and for composite layers described herein include acrylate copolymer pressure sensitive adhesives, rubber based adhesives (e.g., those based on natural rubber, polyisobutylene, polybutadiene, butyl rubbers, styrene block copolymer rubbers, etc.), adhesives based on silicone polyureas or silicone polyoxamides, polyurethane type adhesives, and poly(vinyl ethyl ether), and copolymers or blends of these. Other desirable materials include, for example, styrene-acrylonitrile, cellulose acetate butyrate, cellulose acetate propionate, cellulose triacetate, polyether sulfone, polymethyl methacrylate, polyurethane, polyester, polycarbonate, polyvinyl chloride, polystyrene, polyethylene naphthalate, copolymers or blends based on naphthalene dicarboxylic acids, polyolefins, polyimides, mixtures and/or combinations thereof. Exemplary release materials for extrusion from dies described herein, methods described herein, and for composite layers described herein include silicone-grafted polyolefins such as those described in U.S. Pat. No. 6,465,107 (Kelly) and U.S. Pat. No. 3,471,588 (Kanner et al.), silicone block copolymers such as those described in PCT Publication No. WO96039349, published Dec. 12, 1996, low density polyolefin materials such as those described in U.S. Pat. No. 6,228,449 (Meyer), U.S. Pat. No. 6,348,249 (Meyer), and U.S. Pat. No. 5,948,517 (Meyer), the disclosures of which are incorporated herein by reference.

In some embodiments, the sheath has at least one of a melting or softening point, wherein the core has at least one of a melting or softening point, and where the at least one of the melting or softening point of the sheath is lower than at least one of the melting or softening point of the core.

In some embodiments, the first polymeric stands and the second polymeric stands are both formed with a core sheath arrangement. In particular, the first polymeric strands may have a core of a first polymeric material and a sheath of a second, different polymeric material, and the second polymeric strands may have a core of a third polymeric material and a sheath of a fourth polymeric material. The die design for this scenario will necessarily have 4 cavities. Sheath core strands and single polymer strands can be extruded with two cavities, one cavity for the core and one cavity for the sheath and second strand. It is envisioned that first array of sheath core strands with second array of sheath core strands can be also extruded with two cavities. The first cavity would be for the sheath, the second cavity would be for the cores.

In some embodiments, polymeric materials used to make nettings described herein may comprise a colorant (e.g., pigment and/or dye) for functional (e.g., optical effects) and/or aesthetic purposes (e.g., each has different color/shade). Suitable colorants are those known in the art for use in various polymeric materials. Exemplary colors imparted by the colorant include white, black, red, pink, orange, yellow, green, aqua, purple, and blue. In some embodiments, it is desirable level to have a certain degree of opacity for one or more of the polymeric materials. The amount of colorant(s) to be used in specific embodiments can be readily determined by those skilled in the (e.g., to achieve desired color, tone, opacity, transmissivity, etc.). If desired, the polymeric materials may be formulated to have the same or different colors. When colored strands are of a relatively fine (e.g., less than 50 micrometers) diameter, the appearance of the web may have a shimmer reminiscent of silk.

Strands made using methods described herein do not substantially cross over each other (i.e., at least 50 (at least 55, 60, 65, 70, 75, 80, 85, 90, 95, 99, or even 100) percent by number).

In some embodiments, nettings described herein have a thickness up to 750 micrometers (in some embodiments, up to 500 micrometers, 250 micrometers, 100 micrometers, 75 micrometers, 50 micrometers, or even up to 25 micrometers; in a range from 10 micrometers to 750 micrometers, 10 micrometers to 750 micrometers, 10 micrometers to 500 micrometers, 10 micrometers to 250 micrometers, 10 micrometers to 100 micrometers, 10 micrometers to 75 micrometers, 10 micrometers to 50 micrometers, or even 10 micrometers to 25 micrometers).

In some embodiments, the polymeric strands have an average width in a range from 10 micrometers to 500 micrometers (in a range from 10 micrometers to 400 micrometers, or even 10 micrometers to 250 micrometers).

In some embodiments, nettings described herein have a basis weight in a range from 5 g/m² to 400 g/m² (in some embodiments, 10 g/m² to 200 g/m²), for example, nettings as-made from dies described herein. In some embodiments, nettings described herein after being stretched have a basis weight in a range from 0.5 g/m² to 40 g/m² (in some embodiments, 1 g/m² to 20 g/m²).

In some embodiments, nettings described herein have a strand pitch in a range from 0.5 mm to 20 mm (in some embodiments, in a range from 0.5 mm to 10 mm)

It has been observed that when some of the embodiments of netting made according to the present disclosure are stretched, they will relax to a length that is less than their original length before stretching. While not wishing to be bound by theory, it is believed that this is due to curling of the bond regions within the netting structure.

Optionally, nettings described herein are attached to a backing. The backings may be, for example, one of a film, net, or non-woven. Films may be particularly desirable, for example, for applications utilizing clear printing or graphics. Nonwovens or nets may be particularly desirable, for example, where a softness and quietness that films typically do not have is desired. The netting may be stretched and bonded between at least two layers of film or nonwoven where the bond points have a plurality (at least two) of bond points that do not include the netting in the bond. Alternatively, an unstretched netting could be bonded between at least two layers of film or nonwoven where the bond points have a plurality (at least two) of bond points that do not include the netting in the bond. These constructions may require subsequent stretching, either localized (“ring rolling”) or global, to become an activated elastic laminate

In some embodiments, nettings described herein are elastic. In some embodiments, the polymeric strands have a machine direction and a cross-machine direction, wherein the netting or arrays of polymeric strands is elastic in machine direction, and inelastic in the cross-machine direction. Elastic means that the material will substantially resume its original shape after being stretched (i.e., will sustain only small permanent set following deformation and relaxation which set is less than 50 percent (in some embodiments, less than 25, 20, or even less than 10 percent) of the original length at moderate elongation (i.e., about 400-500% in some embodiments, up to 300% to 1200%, or even up to 600 to 800%) elongation at room temperature). The elastic material can be both pure elastomers and blends with an elastomeric phase or content that will still exhibit substantial elastomeric properties at room temperature.

It is within the scope of the instant disclosure to use heat-shrinkable and non-heat shrinkable elastics. Non-heat shrinkable means that the elastomer, when stretched, will substantially recover sustaining only a small permanent set as discussed above at room temperature (i.e., about 25° C.).

In some embodiments, nettings described herein of alternating first and second polymeric strands exhibit at least one of diamond-shaped or hexagonal-shaped openings.

In some embodiments, the polymeric strands have an average width in a range from 10 micrometers to 500 micrometers (in a range from 10 micrometers to 400 micrometers, or even 10 micrometers to 250 micrometers).

In some embodiments, the strands (i.e., the first strands, second strands, and bond regions, and other optional strands, each have thicknesses that are substantially the same.

In some embodiments, the bond regions have an average largest dimension perpendicular to the strand thickness, and wherein the average largest dimension of the bond regions is at least 2 (in some embodiments, at least 3, 4, 5, 10, or even at least 15) times greater than the average width of at least one of the first strands or the second strands.

In some embodiments, netting described herein includes an array of engagement posts (e.g., hooks) for engaging with the netting. Engagement hooks can be made as is known in the art (see, for example, U.S. Pat. No. 5,077,870 (Melbye et al.)).

Nettings of polymeric strands described herein have a variety of uses, including wound care and other medical applications (e.g., elastic bandage-like material, surface layer for surgical drapes and gowns, and cast padding), tapes (including for medical applications), filtration, absorbent articles (e.g., diapers and feminine hygiene products) (e.g., as a layer(s) within the articles and/or as part of an attachment system for the articles or elastic components), pest control articles (e.g., mosquito nettings), geotextile applications (e.g., erosion control textiles), water/vapor management in clothing, reinforcement for nonwoven articles (e.g., paper towels), self bulking articles (e.g., for packaging) where the netting thickness is increased by stretching nettings with first strands have average first yield strength, and wherein the second strands have an average second yield strength that is different (e.g., at least 10 percent different) than the first yield strength, floor coverings (e.g., rugs and temporary mats), grip supports for tools, athletic articles, breathable elastic wrist and headbands, pattern coated adhesives, and pattern coated adhesives.

Advantages of some embodiments of nettings described herein when used as a backing, for example, for some tapes and wound dressings can include conformability, particularly in the cross direction (e.g., at least 50% elongation in the machine direction).

In some embodiments, nettings described herein are made of, or coated with, hydrophilic material to make them absorbent. In some embodiments, nettings described herein are useful as wound absorbants to remove excess exudate from wounds, and in some embodiments, nettings described herein are made of bioresorbable polymers.

In some filtration applications, the netting can be used, for example, to provide spacers between filtering layers for filtration packs and/or to provide rigidity and support for filtration media. In some embodiments, several layers of the netting are used, where each layer is set to provide optimal filtering. Also, in some embodiments, the elastic feature of some nettings described herein can facilitate expansion the filter as the filter fills up.

In some embodiments, nettings described herein have high and low modulus strands such that stretching netting having a curled bond area can generate a lofted, accessible fiber for hook attachment (i.e., for an attachment system). In such oriented nettings attachment loops can have fiber strengths that are greater than unoriented nettings.

In some embodiments, nettings described herein that are elastic can flex in the machine direction, cross direction, or both directions, which can provide, for example, comfort and fit for diapers and the like. Elastic netting can also provide a breathable, soft, and flexible attachment mechanism (e.g., elastic netting can be attached to posts that fit through the elastic net, the elastic netting can be made with a ribbon region section attached to the netting to provide the fingerlift, the elastic can be made as elastic in one direction and inelastic in the second direction with an elastic and inelastic strand, or the ribbon region section can have molded hooks to provide attachment to a loop).

In some embodiments, nettings described herein useful as grip supports for tools, athletic articles, etc. are made using high friction polymers.

Some embodiments of nettings described herein can be used as or in disposable absorbent articles that may be useful, for example as personal absorbent articles for absorbing bodily fluids (e.g., perspiration, urine, blood, and menses) and disposable household wipes used to clean up similar fluids or typical household spills.

A particular example of a disposable absorbent article comprising nettings described herein are disposable absorbent garments such as infant diapers or training pants, products for adult incontinence, feminine hygiene products (e.g., sanitary napkins and panty liners). A typical disposable absorbent garment of this type is formed as a composite structure including an absorbent assembly disposed between a liquid permeable bodyside liner and a liquid impermeable outer cover. These components can be combined with other materials and features such as elastic materials and containment structures to form a product that is specifically suited to its intended purposes. Feminine hygiene tampons are also well known and generally are constructed of an absorbent assembly and sometimes an outer wrap of a fluid pervious material.

Strands described herein have a variety of uses including fishing lines, and elastic versions for diapers.

Additional information that may be useful in making and using nettings described therein, when combined with the instant disclosure, can be found in application having U.S. Ser. No. 61/526,001, filed Aug. 22, 2011, the disclosure of which is incorporated herein by reference.

### Exemplary Embodiments

1A. A netting comprising an array of (typically adjacent) polymeric strands, wherein the polymeric strands are periodically joined together at bond regions throughout the array, and wherein at least a plurality (i.e., at least two) of the polymeric strands have a core of a first polymeric material and a sheath of a second, different polymeric material, where in at least one of (a) the strands do not substantially cross over each other (i.e., at least 50 (at least 55, 60, 65, 70, 75, 80, 85, 90, 95, 99, or even 100) percent by number) or (b) the netting has a thickness up to 750 micrometers (in some embodiments, up to 500 micrometers, 250 micrometers, 100 micrometers, 75 micrometers, 50 micrometers, or even up to 25 micrometers; in a range from 10 micrometers to 750 micrometers, 10 micrometers to 750 micrometers, 10 micrometers to 500 micrometers, 10 micrometers to 250 micrometers, 10 micrometers to 100 micrometers, 10 micrometers to 75 micrometers, 10 micrometers to 50 micrometers, or even 10 micrometers to 25 micrometers).

2A. The netting of Embodiment 1A that is an extruded netting.

3A. The netting of any preceding Embodiment, wherein at least some of the cores have at least two (in some embodiments at least 3 or more) sheaths.

4A. The netting of any preceding Embodiment having a basis weight in a range from 5 g/m² to 400 g/m² (in some embodiments, 10 g/m² to 200 g/m²).

5A. The netting of any of Embodiments 1A to 3A having a basis weight in a range from 0.5 g/m² to 40 g/m² (in some embodiments, 1 g/m² to 20 g/m²).

6A. The netting of any preceding Embodiment having a strand pitch in a range from 0.5 mm to 20 mm (in some embodiments, in a range from 0.5 mm to 10 mm)

7A. The netting of any preceding Embodiment having a negative permanent set.

8A. The netting of any of Embodiments 1A to 6A that is elastic.

9A. The netting of any of Embodiments 1A to 6A having a machine direction and a cross-machine direction, wherein the netting is elastic in machine direction, and inelastic in the cross-machine direction.

10A. The netting of any of Embodiments 1A to 6A having a machine direction and a cross-machine direction, wherein the netting is inelastic in machine direction, and elastic in the cross-machine direction.

11A. The nettings of any preceding Embodiment where the netting is stretched.

12A. The netting of any preceding Embodiment, wherein the bond regions have an average largest dimension perpendicular to the strand thickness, and wherein the average largest dimension of the bond regions is at least 2 (in some embodiments, at least 3, 4, 5, 10, or even at least 15) times greater than the average width of at least one of the first strands or the second strands.

13A. The netting of any preceding Embodiment, wherein at least one of the first or second polymeric material includes at least one of a dye or pigment therein.

14A. The netting of any preceding Embodiment, wherein the array of polymeric strands exhibits at least one of diamond-shaped or hexagonal-shaped openings.

15A. The netting of any preceding Embodiment, wherein the first and second polymers are independently a thermoplastic (e.g., adhesives, nylons, polyesters, polyolefins, polyurethanes, elastomers (e.g., styrenic block copolymers), and blends thereof.

16A. The netting of any preceding Embodiment, wherein the polymeric strands have an average width in a range from 10 micrometers to 500 micrometers (in a range from 10 micrometers to 400 micrometers, or even 10 micrometers to 250 micrometers).

17A. The netting of any preceding Embodiment, wherein the plurality of strands include alternating first and second polymeric strands.

18A. The netting of Embodiment 17A, wherein the second strands have an average width in a range from 10 micrometers to 500 micrometers (in a range from 10 micrometers to 400 micrometers, or even 10 micrometers to 250 micrometers).

19A. The netting of any preceding Embodiment, wherein the sheath has at least one of a melting or softening point, wherein the core has at least one of a melting or softening point, and where the at least one of the melting or softening point of the sheath is lower than at least one of the melting or softening point of the core.

20A. An article comprising a backing having the netting of any preceding Embodiment on a major surface thereof.

21A. The article of Embodiment 20A, wherein the backing is one of a film, net, or non-woven.

22A. The article of Embodiment 21A that includes bond lines.

23A. An article comprising the netting of any of Embodiment 1A to 19A disposed between two non-woven layers.

24A. An article comprising two nettings of any of Embodiments 1A to 19A with a ribbon region disposed there between.

25A. The article of Embodiment 24A, wherein the netting and ribbon region are integral.

26A. An article comprising the netting of any of Embodiments 1A to 19A disposed between two ribbon regions.

27A. The article of Embodiment 26A, wherein the netting is integral with each of the ribbon regions.

28A. An attachment system comprising the netting of any of Embodiments 1A to 19A and an array of engagement posts (e.g., hooks) for engaging with the netting.

29A. An incontinence article comprising the attachment system of Embodiment 28A.

30A. A method of making the netting of any of Embodiments 1A to 19A, the method comprising:

providing an extrusion die comprising a plurality of shims positioned adjacent to one another, the shims together defining at least a first cavity and a second cavity, and a dispensing surface, wherein the dispensing surface has an array of dispensing orifices defined by an array of vestibules, wherein the plurality of shims comprises a plurality of a repeating sequence of shims, wherein the repeating sequence comprises: shims that provide a fluid passageway between the first cavity and one of the vestibules, shims that provide a second passageway extending from the second cavity to the same vestibule, and shims that provide a third passageway extending from the second cavity to the same vestibule, wherein each of the second and third passageways is on opposite sides of the first passageway, and each of the second and third passageways has a dimension larger than the first passageway at the point where the first passageway enters the vestibule; and

dispensing first polymeric strands from the first dispensing orifices at a first strand speed while simultaneously dispensing second polymeric strands from the second dispensing orifices at a second strand speed, wherein the first strand speed is at least 2 (in some embodiments, in a range from 2 to 6, or even 2 to 4) times the second strand speed to provide the netting.

31A. A method of making the netting of any of Embodiments 1A to 19A, the method comprising:

providing an extrusion die comprising a plurality of shims positioned adjacent to one another, the shims together defining at least a first cavity and a second cavity, and a dispensing surface, wherein the dispensing surface has an first array of first dispensing orifices defined by an array of vestibules, and a second array of second dispensing orifices, wherein the plurality of shims comprises a plurality of a repeating sequence of shims, wherein the repeating sequence comprises shims that provide a fluid passageway between the first cavity and one of the vestibules, shims that provide a second passageway extending from the second cavity to the same vestibule, and shims that provide a third passageway extending from the second cavity to the same vestibule, wherein each of the second and third passageways is on opposite sides of the first passageway, and each of the second and third passageways has a dimension larger than the first passageway at the point where the first passageway enters the vestibule, and wherein the repeating sequence further comprises shims that provide a passageway from a cavity to one of the second dispensing orifices; and

dispensing first polymeric strands from first dispensing orifices of the array at a first strand speed while simultaneously dispensing second polymeric strands from second dispensing orifices of the array at a second strand speed, wherein the first strand speed is at least 2 (in some embodiments, in a range from 2 to 6, or even 2 to 4) times the second strand speed to provide the netting.

1B. An extrusion die having at least first and second cavities, a first passageway extending from the first cavity into a vestibule defining a dispensing orifice, and second and third passageways extending from the second cavity to the vestibule, each on opposite sides of the first passageway, and each having a dimension larger than the first passageway at the point where the first passageway enters the vestibule.

2B A method of making a polymeric strand have a core of a first polymeric material and a sheath of a second, different polymeric material, the method comprising dispensing the polymeric strand from the dispensing orifice of the extrusion die of Embodiment 1B.

1C. An extrusion die comprising a plurality of shims positioned adjacent to one another, the shims together defining at least a first cavity and a second cavity, and a dispensing surface, wherein the dispensing surface has an array of dispensing orifices defined by an array of vestibules, wherein the plurality of shims comprises a plurality of a repeating sequence of shims, wherein the repeating sequence comprises: shims that provide a fluid passageway between the first cavity and one of the vestibules, shims that provide a second passageway extending from the second cavity to the same vestibule, and shims that provide a third passageway extending from the second cavity to the same vestibule, wherein each of the second and third passageways is on opposite sides of the first passageway, and each of the second and third passageways has a dimension larger than the first passageway at the point where the first passageway enters the vestibule.

2C. The extrusion die of Embodiment 1C, wherein the repeating sequence further comprises at least one spacer shim.

3C. The extrusion die of either Embodiment 1C or 2C comprising at least 1000 of the shims.

4C. The extrusion die of any of Embodiments 1C to 3C, wherein the first dispensing orifices and the second dispensing orifices are collinear.

5C. The extrusion die of any of Embodiments 1C to 4C, wherein the first dispensing orifices are collinear, and the second dispensing orifices are collinear but offset from the first dispensing orifices.

6C. The extrusion die of any of Embodiments 1C to 5C further comprising a manifold body for supporting the shims, the manifold body having at least one manifold therein, the manifold having an outlet; and further comprising an expansion seal disposed so as to seal the manifold body and the shims, wherein the expansion seal defines a portion of at least one of the cavities, and wherein the expansion seal allows a conduit between the manifold and the cavity.

7C. The extrusion die of Embodiment 6C, wherein the expansion seal defines a portion of both the first and the second cavities.

8C. The extrusion die of any of Embodiments 1C to 7C, wherein each of the dispensing orifices of the first and the second arrays have a width, and wherein each of the dispensing orifices of the first and the second arrays are separated by no more than twice the width of the respective dispensing orifice.

9C. The extrusion die of any of Embodiments 1C to 8C, wherein the fluid passageway is up to 5 mm in length.

10C. A method of making a polymeric strands having a core of a first polymeric material and a sheath of a second, different polymeric material, the method comprising using the extrusion die of any of Embodiments 1C to 9C to dispense the polymeric strands from the array of dispensing orifices.

1D. An extrusion die comprising a plurality of shims positioned adjacent to one another, the shims together defining at least a first cavity and a second cavity, and a dispensing surface, wherein the dispensing surface has an first array of first dispensing orifices defined by an array of vestibules, and a second array of second dispensing orifices, wherein the plurality of shims comprises a plurality of a repeating sequence of shims, wherein the repeating sequence comprises shims that provide a fluid passageway between the first cavity and one of the vestibules, shims that provide a second passageway extending from the second cavity to the same vestibule, and shims that provide a third passageway extending from the second cavity to the same vestibule, wherein each of the second and third passageways is on opposite sides of the first passageway, and each of the second and third passageways has a dimension larger than the first passageway at the point where the first passageway enters the vestibule, and wherein the repeating sequence further comprises shims that provide a passageway from a cavity to one of the second dispensing orifices.

2D. The extrusion die of Embodiment 1D, wherein the repeating sequence further comprises at least one spacer shim.

3D. The extrusion die of either Embodiment 1D or 2D comprising at least 1000 of the shims.

4D. The extrusion die of any of Embodiments 1D to 3D, wherein the first dispensing orifices and the second dispensing orifices are collinear.

5D. The extrusion die of any of Embodiments 1D to 4D, wherein the first dispensing orifices are collinear, and the second dispensing orifices are collinear but offset from the first dispensing orifices.

6D. The extrusion die of any of Embodiments 1D to 5D further comprising a manifold body for supporting the shims, the manifold body having at least one manifold therein, the manifold having an outlet; and further comprising an expansion seal disposed so as to seal the manifold body and the shims, wherein the expansion seal defines a portion of at least one of the cavities, and wherein the expansion seal allows a conduit between the manifold and the cavity.

7D. The extrusion die of any of Embodiment 6D, wherein the expansion seal defines a portion of both the first and the second cavities.

8D. The extrusion die of any of Embodiments 1D to 7D, wherein each of the dispensing orifices of the first and the second arrays have a width, and wherein each of the dispensing orifices of the first and the second arrays are separated by no more than twice the width of the respective dispensing orifice.

9D. The extrusion die of any of Embodiments 1D to 8D, wherein the first and second cavities are supplied with a first polymer at a first pressure and a second polymer at a second pressure so as to dispense a core/sheath strand from the first array at a first strand speed, wherein the second dispensing orifices are supplied with a polymer at a pressure so as to dispense the strands from the second array at a second strand speed, and further wherein the first and second strand speeds are different from each other by least 2 (in some embodiments in a range from 2 to 6, or even 2 to 4) times, such that a netting comprising an array of alternating first and second polymeric strands is formed.

10D. The extrusion die of any of Embodiments 1D to 9D, wherein the shims together define a third cavity, and the second dispensing orifices are supplied from the third cavity.

11D. A method of making a polymeric strands having a core of a first polymeric material and a sheath of a second, different polymeric material, the method comprising using the extrusion die of any of Embodiments 1D to 9D to dispense the polymeric strands from the arrays of dispensing orifices.

1E. An extrusion die comprising a plurality of shims positioned adjacent to one another, the shims together defining at least a first cavity and a second cavity and a dispensing surface, wherein the dispensing surface has at least one net-forming zone and at least one ribbon-forming zone, wherein the dispensing surface within the net-forming zone has a zone has an first array of first dispensing orifices defined by an array of vestibules, and a second array of second dispensing orifices, wherein the plurality of shims comprises a plurality of a repeating sequence of shims, wherein the repeating sequence comprises shims that provide a fluid passageway between the first cavity and one of the vestibules, shims that provide a second passageway extending from the second cavity to the same vestibule, and shims that provide a third passageway extending from the second cavity to the same vestibule, wherein each of the second and third passageways is on opposite sides of the first passageway, and each of the second and third passageways has a dimension larger than the first passageway at the point where the first passageway enters the vestibule and wherein the repeating sequence further comprises shims that provide a passageway from a cavity to the array of second dispensing orifices.

2E. The extrusion die of Embodiment 1E, wherein the repeating sequence further comprises at least one spacer shim.

3E. The extrusion die of either Embodiment 1E or 2E comprising at least 1000 of the shims.

4E. The extrusion die of any of Embodiments 1E to 3E, wherein the first dispensing orifices and the second dispensing orifices are collinear.

5E. The extrusion die of any of Embodiments 1E to 4E, wherein the first dispensing orifices are collinear, and the second dispensing orifices are collinear but offset from the first dispensing orifices.

6E. The extrusion die of any of Embodiments 1E to 5E further comprising a manifold body for supporting the shims, the manifold body having at least one manifold therein, the manifold having an outlet; and further comprising an expansion seal disposed so as to seal the manifold body and the shims, wherein the expansion seal defines a portion of at least one of the cavities, and wherein the expansion seal allows a conduit between the manifold and the cavity.

7E. The extrusion die of any of Embodiment 6E, wherein the expansion seal defines a portion of both the first and the second cavities.

8E. The extrusion die of any of Embodiments 1E to 7E, wherein each of the dispensing orifices of the first and the second arrays have a width, and wherein each of the dispensing orifices of the first and the second arrays are separated by no more than twice the width of the respective dispensing orifice.

9E. The extrusion die of any of Embodiments 1E to 8E, wherein the first and second cavities are supplied with a first polymer at a first pressure and a second polymer at a second pressure so as to dispense a core/sheath strand from the first array at a first strand speed, wherein the second dispensing orifices are supplied with a polymer at a pressure so as to dispense the strands from the second array at a second strand speed, and further wherein the first and second strand speeds are different from each other by least 2 (in some embodiments in a range from 2 to 6, or even 2 to 4) times, such that a netting comprising an array of alternating first and second polymeric strands is formed.

10E. The extrusion die of any of Embodiments 1E to 9E, wherein the ribbon forming zone has a dispensing slot, and polymer is dispensed from a cavity into the dispensing slot so as to form a ribbon attached to the netting.

Advantages and embodiments of this invention are further illustrated by the following examples, but the particular materials and amounts thereof recited in these examples, as well as other conditions and details, should not be construed to unduly limit this invention. All parts and percentages are by weight unless otherwise indicated.

### Example

A co-extrusion die as generally depicted in FIG. 10, with three manifold cavities was prepared. Five unique shims were set up in a repeat sequence of 14 shims per repeat as generally illustrated in FIG. 6. The first and second shims were 4 mils (0.102 mm) thick spacer shims 4440 as generally illustrated in FIG. 1. The third, fourth, fifth, and sixth shims were each 4 mils (0.102 mm) thick, and had passageway 4568b connection to first cavity 4462b as generally illustrated in FIG. 2. First cavity 4462b and connected orifice 4566 provided for extrusion of the single polymer strand. The seventh and eighth shims were spacer shims, the same as the first and second shims. The ninth and fourteenth shims were 2 mil (0.51 mm) shims with passageway connection 4668a to the third cavity 4462a as generally illustrated in FIG. 3. Third cavity 4462a and passageway 4668a provided for extrusion of the sheath polymer. The tenth and thirteenth shims were 2 mils (0.051 mm) thick spacer shims as generally illustrated in FIG. 4. The eleventh and twelfth shims were 4 mils (0.102 mm) thick with passageway connection 4868c to second cavity 4462c as generally illustrated in FIG. 5. Second cavity 4462c and passageway 4868c provided for extrusion of the polymer core. The shims were formed from stainless steel, with perforations cut by a wire electron discharge machining. The height of the first extrusion orifice was cut to 30 mils (0.762 mm) The height of the second set of extrusion orifices was cut to 30 mils (0.762 mm) The passageway of the shims connected to the second cavity had a reduced width in the passageway section of 10 mils (0.254 mm) The tenth and thirteenth spacer shims were formed to create a cavity to enable encapsulation of the second cavity polymer by the third cavity polymer. The extrusion orifices were aligned in a collinear, alternating arrangement. The total width of the shim setup was 15 cm.

The inlet fittings on the two end blocks were each connected to a conventional single-screw extruder. A chill roll was positioned adjacent to the distal opening of the coextrusion die to receive the extruded material. The extruder feeding the first cavity was loaded with a polypropylene copolymer resin (obtained under the trade designation “VISTAMAX 3000” from ExxonMobil).

The extruder feeding the second cavity was loaded with styrene isoprene styrene block copolymer pellets (obtained under the trade designation “KRATON 1114” from Kraton Polymers, Houston, Tex.).

The extruder feeding the third cavity was loaded with one hundred melt flow index polypropylene pellets (obtained under the trade designation “TOTAL 3860” from Total Petrochemicals, Houston Tex.).

Other process conditions are listed below:

| Orifice width for the first cavity: | 0.406 | mm |
|---|---|---|
| Orifice height for the first cavity: | 0.762 | mm\ |
| Orifice width of the second and third cavity: | 0.406 | mm |
| Orifice height of the second and third cavity: | 0.762 | mm |
| Ratio of orifice height to width for oscillating strand | 1.87:1 | |
| Ratio of first and second orifice area | 1:1 | |
| Land spacing between orifices | 0.203 | mm |
| Flow rate of first polymer | 1.27 | kg/hr. |
| Flow rate of second polymer | 3.18 | kg/hr. |
| Flow rate of the third polymer | 0.32 | kg/hr. |
| Flow rate ratio first to second orifice | 0.36:1 | |
| Core to sheath ratio | 10:1 | |
| Extrusion temperature | 227° | C. |
| Quench roll temperature | 15° | C. |
| Quench takeaway speed | 3 | m/min. |

Using an optical microscope, the netting dimensions were measured and are shown below.

| | | |
|---|---|---|
| Netting thickness | 0.50 | mm |
| Netting basis weight | 170 | grams |
| Bond length in the machine direction | 1.4 | mm |
| Netting bond distance in the machine direction (pitch) | 4.7 | mm |
| First orifice strand width | 0.16 | mm |
| Second orifice strand width | 0.35 | mm |

The resulting netting had first to second strand cross-sections with a cross sectional area ratio of 0.36:1. An optical photograph of the netting is shown in FIG. 14.

Foreseeable modifications and alterations of this disclosure will be apparent to those skilled in the art without departing from the scope and spirit of this invention. This invention should not be restricted to the embodiments that are set forth in this application for illustrative purposes.

1. A netting comprising an array of polymeric strands, wherein the polymeric strands are periodically joined together at bond regions throughout the array, and wherein at least a plurality of the polymeric strands have a core of a first polymeric material and a sheath of a second, different polymeric material, where in at least one of (a) the strands do not substantially cross over each other or (b) the netting has a thickness up to 750 micrometers.

2. The netting of claim 1 having a basis weight in a range from 5 g/m² to 400 g/m².

3. The netting of claim 1 having a basis weight in a range from 0.5 g/m² to 40 g/m².

4. A method of making the netting of claim 1, the method comprising:
providing an extrusion die comprising a plurality of shims positioned adjacent to one another, the shims together defining at least a first cavity and a second cavity, and a dispensing surface, wherein the dispensing surface has an array of dispensing orifices defined by an array of vestibules, wherein the plurality of shims comprises a plurality of a repeating sequence of shims, wherein the repeating sequence comprises: shims that provide a fluid passageway between the first cavity and one of the vestibules, shims that provide a second passageway extending from the second cavity to the same vestibule, and shims that provide a third passageway extending from the second cavity to the same vestibule, wherein each of the second and third passageways is on opposite sides of the first passageway, and each of the second and third passageways has a dimension larger than the first passageway at the point where the first passageway enters the vestibule; and
dispensing first polymeric strands from the first dispensing orifices at a first strand speed while simultaneously dispensing second polymeric strands from the second dispensing orifices at a second strand speed, wherein the first strand speed is at least 2 times the second strand speed to provide the netting.

5. A method of making the netting of claim 1, the method comprising:
providing an extrusion die comprising a plurality of shims positioned adjacent to one another, the shims together defining at least a first cavity and a second cavity, and a dispensing surface, wherein the dispensing surface has an first array of first dispensing orifices defined by an array of vestibules, and a second array of second dispensing orifices, wherein the plurality of shims comprises a plurality of a repeating sequence of shims, wherein the repeating sequence comprises shims that provide a fluid passageway between the first cavity and one of the vestibules, shims that provide a second passageway extending from the second cavity to the same vestibule, and shims that provide a third passageway extending from the second cavity to the same vestibule, wherein each of the second and third passageways is on opposite sides of the first passageway, and each of the second and third passageways has a dimension larger than the first passageway at the point where the first passageway enters the vestibule, and wherein the repeating sequence further comprises shims that provide a passageway from a cavity to one of the second dispensing orifices; and
dispensing first polymeric strands from first dispensing orifices of the array at a first strand speed while simultaneously dispensing second polymeric strands from second dispensing orifices of the array at a second strand speed, wherein the first strand speed is at least 2 times the second strand speed to provide the netting.

6. An extrusion die having at least first and second cavities, a first passageway extending from the first cavity into a vestibule defining a dispensing orifice, and second and third passageways extending from the second cavity to the vestibule, each on opposite sides of the first passageway, and each having a dimension larger than the first passageway at the point where the first passageway enters the vestibule.

7. A method of making a polymeric strand have a core of a first polymeric material and a sheath of a second, different polymeric material, the method comprising dispensing the polymeric strand from the dispensing orifice of the extrusion die of claim 6.

8. An extrusion die comprising a plurality of shims positioned adjacent to one another, the shims together defining at least a first cavity and a second cavity, and a dispensing surface, wherein the dispensing surface has an array of dispensing orifices defined by an array of vestibules, wherein the plurality of shims comprises a plurality of a repeating sequence of shims, wherein the repeating sequence comprises: shims that provide a fluid passageway between the first cavity and one of the vestibules, shims that provide a second passageway extending from the second cavity to the same vestibule, and shims that provide a third passageway extending from the second cavity to the same vestibule, wherein each of the second and third passageways is on opposite sides of the first passageway, and each of the second and third passageways has a dimension larger than the first passageway at the point where the first passageway enters the vestibule.

9. A method of making a polymeric strands having a core of a first polymeric material and a sheath of a second, different polymeric material, the method comprising using the extrusion die of claim 8 to dispense the polymeric strands from the array of dispensing orifices.

10. An extrusion die comprising a plurality of shims positioned adjacent to one another, the shims together defining at least a first cavity and a second cavity, and a dispensing surface, wherein the dispensing surface has an first array of first dispensing orifices defined by an array of vestibules, and a second array of second dispensing orifices, wherein the plurality of shims comprises a plurality of a repeating sequence of shims, wherein the repeating sequence comprises shims that provide a fluid passageway between the first cavity and one of the vestibules, shims that provide a second passageway extending from the second cavity to the same vestibule, and shims that provide a third passageway extending from the second cavity to the same vestibule, wherein each of the second and third passageways is on opposite sides of the first passageway, and each of the second and third passageways has a dimension larger than the first passageway at the point where the first passageway enters the vestibule, and wherein the repeating sequence further comprises shims that provide a passageway from a cavity to one of the second dispensing orifices.

11. A method of making a polymeric strands having a core of a first polymeric material and a sheath of a second, different polymeric material, the method comprising using the extrusion die of claim 10 to dispense the polymeric strands from the arrays of dispensing orifices.

12. An extrusion die comprising a plurality of shims positioned adjacent to one another, the shims together defining at least a first cavity and a second cavity and a dispensing surface, wherein the dispensing surface has at least one net-forming zone and at least one ribbon-forming zone, wherein the dispensing surface within the net-forming zone has a zone has an first array of first dispensing orifices defined by an array of vestibules, and a second array of second dispensing orifices, wherein the plurality of shims comprises a plurality of a repeating sequence of shims, wherein the repeating sequence comprises shims that provide a fluid passageway between the first cavity and one of the vestibules, shims that provide a second passageway extending from the second cavity to the same vestibule, and shims that provide a third passageway extending from the second cavity to the same vestibule, wherein each of the second and third passageways is on opposite sides of the first passageway, and each of the second and third passageways has a dimension larger than the first passageway at the point where the first passageway enters the vestibule and wherein the repeating sequence further comprises shims that provide a passageway from a cavity to the array of second dispensing orifices.
